(19) United States
(12) Patent Application Publication
(10) Pub. No.: US 2012/0109394 A1
(43) Pub. Date: May 3, 2012

(54) Household Energy Management System

(76) Inventors: Yasuo Takagi, Kanagawa-ken (JP); Takahiro Yamada, Kanagawa-ken (JP); Masahiko Murai, Tokyo (JP); Tomohiko Tanimoto, Tokyo (JP)

(21) Appl. No.: 13/283,213

(22) Filed: Oct. 27, 2011

(30) Foreign Application Priority Data
Oct. 28, 2010 (JP) 2010-242823

(51) Int. Cl. G05B 15/00

(52) U.S. Cl. 700/291

(57) ABSTRACT

A household energy management system includes: a schedule condition storage unit for storing schedule conditions that include operation-permitting time zones indicating time zones during which household electric appliances are permitted to operate, necessary operation times indicating operation times taken for the household electric appliances to finish operation, and operation time power consumption amounts indicating electric power consumed during the operation of the household electric appliances; a schedule calculation unit for receiving a CO2 emission intensity from a grid energy management system and for preparing operation schedules indicating operation times of the household electric appliances based on the CO2 emission intensity and the schedule conditions; and a control unit for controlling the household electric appliances based on the operation schedules.

### CROSS-REFERENCE TO RELATED APPLICATIONS

This application is based upon and claims the benefit of priority from Japanese Patent Applications No. 2010-242823, filed on Oct. 28, 2010, the entire content of which are incorporated herein by reference.

### TECHNICAL FIELD

The present disclosure relates to a household energy management system.

### BACKGROUND

There is already known a household energy management system that can realize energy saving, cost saving and reduction of CO₂ emission by displaying and sometimes controlling the energy consumed by a number of appliances provided within an electricity consumer entity such as a home or a shop (hereinafter referred to as “consumer entity”). The conventional household energy management system includes electric appliances provided in the consumer entity and a control device for controlling the electric appliances. The electric appliances include a plurality of household electric appliances in case of the consumer entity being a home.

The household energy management system can mainly perform the following tasks: (1) the user absence control of an air conditioner by which the air conditioner is turned off if no user exists; (2) the user absence/brightness control of an illumination lamp by which the illumination lamp is turned off or made darker if no user exists; and (3) the standby power cutoff by which the standby power otherwise consumed by household electric appliances is cut off

Examples of the indications on the consumed energy displayed in the household energy management system include: an indication of electric power consumption amount and gas consumption amount within a consumer entity; an indication regarding the results of energy saving contest between a plurality of households; an indication of advice message pursuant to the ambient temperature; and an indication of CO₂ emission.

However, it is often the case that the energy saving effect attained by the automatic control of household electric appliances is not so great within the consumer entity employing the conventional household energy management system. To realize increased energy saving, it is necessary for a dweller to actively cooperate in reducing energy consumption. In seeking the dweller's active cooperation, a burden is imposed on the dweller to personally operate, e.g., turn on and off, household electric appliances.

### BRIEF DESCRIPTION OF THE DRAWINGS

FIG. 1 is a view showing the configuration of a household energy management system according to one embodiment.

FIG. 2A is a view showing one example of the unit electricity price supplied from a grid energy management system and received by the household energy management system according to one embodiment.

FIG. 2B is a view showing one example of the CO2 emission intensity supplied from the grid energy management system and received by the household energy management system according to one embodiment.

FIG. 3 is a view showing the DR (Demand Response) conditions of the household energy management system according to one embodiment.

FIG. 4 is a view showing the schedule conditions of the household energy management system according to one embodiment.

FIG. 5 is a view showing the operation schedules of the household energy management system according to one embodiment.

FIG. 6 is a view showing the DR schedules of the household energy management system according to one embodiment.

### DETAILED DESCRIPTION

A household energy management system according to one embodiment of the present disclosure will now be described with reference to the accompanying drawings.

### Embodiment

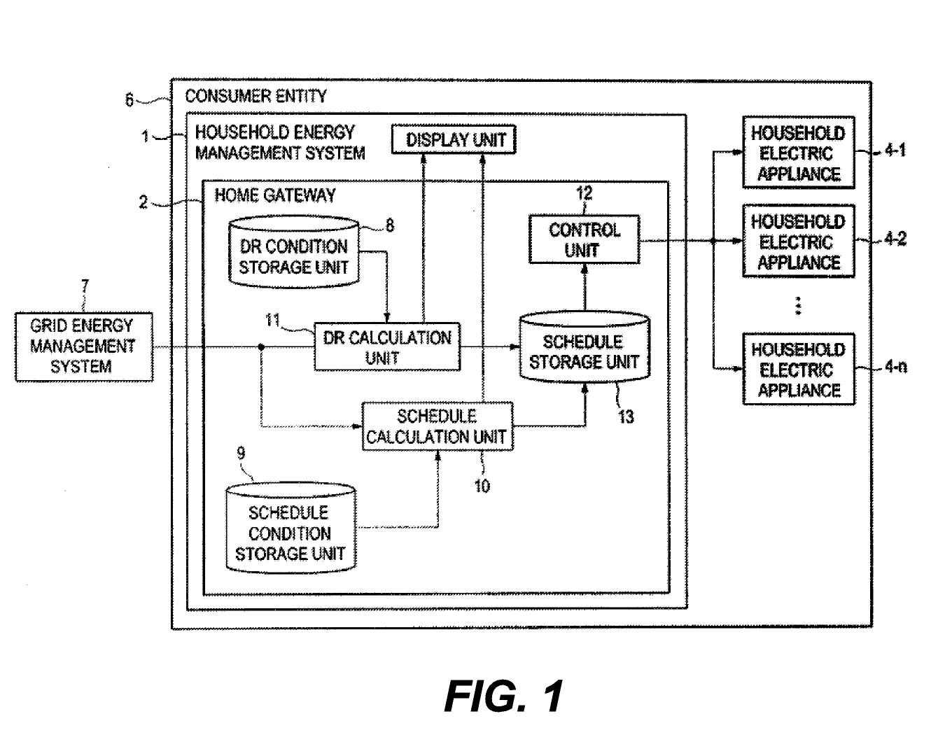

The configuration of a household energy management system according to one embodiment will be described with reference to FIG. 1, which shows the relationship between the household energy management system and the peripheral appliances.

The household energy management system 1 includes a home gateway 2 and a display unit 3.

The home gateway 2 includes a DR (Demand Response) condition storage unit 8, a schedule condition storage unit 9, a schedule calculation unit 10, a DR calculation unit 11, a control unit 12 and a schedule storage unit 13. The home gateway 2 is connected to a plurality of household electric appliances 4-1, 4-2, . . . and 4-n installed in a consumer entity 6 via a local area network (hereinafter referred to as “LAN”) of the consumer entity 6. As used herein, the term “household electric appliances 4-1 to 4-n” is intended to mean electric appliances for daily life such as a television set, an air conditioner, an illumination lamp and a battery.

The home gateway 2 is also connected to a grid energy management system 7 via a communication line to receive a unit electricity price indicating the time-dependently changing price of the electric power, a grid CO2 emission intensity indicating the time-dependently changing CO2 emission intensity of the electric power and a power consumption control request. Response of the household energy management system 1 to a power consumption control request is DR (Demand Response).

Description will be given on the unit electricity price, the grid CO2 emission intensity and the power consumption control request received from the grid energy management system 7.

### (Unit Electricity Price and Grid CO2 Emission Intensity)

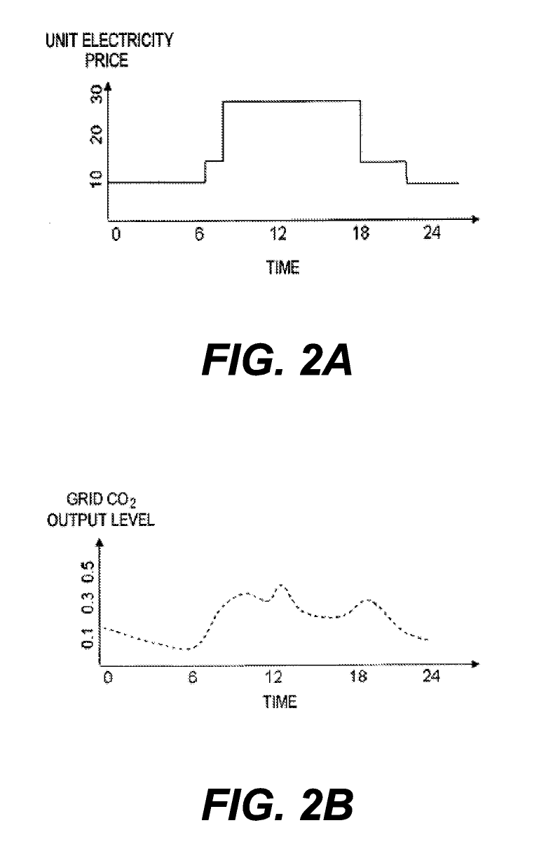

The unit electricity price and the grid CO2 emission intensity are shown in FIGS. 2A and 2B. FIG. 2A shows a time-dependent change of the “Unit Electricity Price,” while FIG. 2B represents a time-dependent change of the “Grid CO2 emission intensity.” In this regard, the household energy management system 1 receives the “Unit Electricity Price” and the “Grid CO2 emission intensity” in a low cycle (once a day) to see one-day trend thereof

The “Unit Electricity Price” shown in FIG. 2A denotes the price per 1 kWh of the electric power. The unit electricity price is 10 yen/kWh at zero to six o'clock, 15 yen/kWh at six to seven o'clock, 30 yen/kWh at seven to eighteen o'clock, 15 yen/kWh at eighteen to twenty two o'clock and 10 yen/kWh at twenty two to twenty four o'clock. The unit electricity price is changed by an electric power supplier.

The “Grid CO2 emission intensity” represented in FIG. 2B signifies the CO₂ emission amount per 1 kWh of the electric power generated by all the power generators installed in a grid. The “Grid CO2 emission intensity” is time-dependently changed depending on the ratio of power outputs generated by different power generators (e.g., a fossil fuel power plant and a nuclear power plant) in the total power outputs. More specifically, the “Grid CO2 emission intensity” becomes smaller at zero to six o'clock because the percentage of the power output generated by a nuclear power plant having a reduced grid CO2 emission intensity is kept greater during that time period. The “Grid CO2 emission intensity” grows higher at six to twelve o'clock because the percentage of the power output generated by a fossil fuel power plant having an increased grid CO2 emission intensity is kept greater during that time period.

The “Grid CO2 emission intensity” UP is calculated by the grid energy management system 7 by using equation (1):

UP=(UNuclear×PNuclear+UCoal×PCoal)/TP (1),

wherein: UNuclear and UCoal are the CO₂ emission levels of nuclear power generation and fossil fuel power generation calculated and set in advance, respectively; PNuclear and PCoal are the power outputs generated by the nuclear power generator and the fossil fuel generator, respectively; and TP is the total power output generated by all the power generators installed in the grid.

### (Power Consumption Control Request)

The power consumption control request indicates control contents required for the consumer entity 6 and contains control levels and control times. In this regard, the control levels are the levels indicating the reduction amount of power consumption required for the consumer entity 6 to accomplish. The control levels are divided into, e.g., three stages, level 1, level 2 and level 3. The reduction amount of power consumption required in level 1 is smaller than that required in level 2. The control times mean the time at which the power consumption control request is issued.

The power consumption control request may further contain information on the household electric appliances to be controlled, the predicted future weather and temperature and the degree of urgency of the control. The information thus received may go through an electricity meter and an information modem (not shown) installed in the consumer entity 6.

Next, description will be given on the respective units provided in the home gateway 2 of the household energy management system.

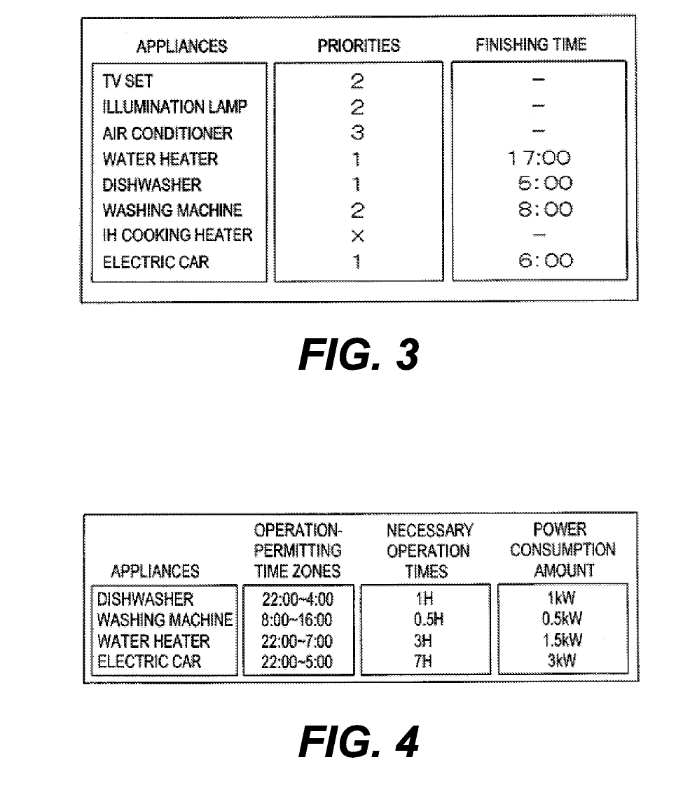

The DR condition storage unit 8 stores the predetermined DR conditions of the household electric appliances 4-1 to 4-n. The DR conditions will be described with reference to FIG. 3, which shows one example of the DR conditions when the household electric appliances 4-1 to 4-n include a television set, an air conditioner, an illumination lamp, a water heater, a dishwasher, a washing machine, an IH cooking heater and an electric car.

In FIG. 3, there are shown the control contents of the household electric appliances 4-1 to 4-n and the priorities corresponding to the control contents. The priorities are set in multiple stages to read, e.g., “1,” “2” and “3.” The control operation of priority 1 is more preferentially performed than the control operations of priorities 2 and 3. More specifically, when the power is turned off, the water heater and the washing machine, whose operations likely have little effect on the homeowner, are given priority “1” and the power consumption control thereof is performed on a preferential basis. On the other hand, the television set, the air conditioner and the illumination lamp, which have some influences on the real life, are given priority “2” to reduce the priority order thereof. The IH cooking heater having a great influence on the real life is given priority “X” and the power consumption control thereof is not performed.

The “Finishing Time” denotes the time at which the operations of the household electric appliances 4-1 to 4-n are to be finished. For example, it is desirable for the water heater to finish producing hot water by 5:00, p.m. Thus, the finishing time of the water heater is set to read “17:00.”

The schedule condition storage unit 9 stores the schedule conditions of the household electric appliances 4-1 to 4-n. The schedule conditions will be described with reference to FIG. 4, which shows one example of the schedule conditions of the household electric appliances 4-1 to 4-n. The schedule conditions include operation-permitting time zones indicating time zones during which the household electric appliances 4-1 to 4-n are permitted to operate, necessary operation times indicating operation times taken for the household electric appliances 4-1 to 4-n to finish operation, and operation time power consumption amounts indicating electric power consumed during the operation of the household electric appliances 4-1 to 4-n.

The operation-permitting time zone of the dishwasher is set to read “22:00˜4:00.” The dishwasher is permitted to operate only during this time zone. The necessary operation time is set to read “1 H,” which means that one hour is required for the dishwasher to finish its operation. The operation time power consumption is set to read “1 kW,” which indicates the power to be consumed during operation of the dishwasher.

Using the schedule conditions stored in the schedule condition storage unit 9, the grid CO2 emission intensity, and the unit electric price received from the grid energy management system 7, the schedule calculation unit 10 prepares operation schedules for the household electric appliances 4-1 to 4-n and causes the operation schedules to be displayed on the display unit 3. If it is determined that an approval signal indicating the dweller's approval of the operation schedules is inputted through an input unit (not shown), then the schedule calculation unit 10 has the operation schedules stored in the schedule storage unit 13.

Based on the grid CO2 emission intensity and the power consumption control request received from the grid energy management system 7 and the DR conditions stored in the DR condition storage unit 8, the DR calculation unit 11 prepares DR schedules and causes the DR schedules to be displayed on the display unit 3. If it is determined that an approval signal indicating the dweller's approval of the DR schedules is inputted through an input unit (not shown), then the DR calculation unit 11 has the operation schedules stored in the schedule storage unit 13.

The control unit 12 controls the household electric appliances 4-1 to 4-n pursuant to the operation schedules and the DR schedules prepared by the schedule calculation unit 10 and the DR calculation unit 11.

Description will now be made on the operation of the household energy management system having the configuration described above. A case where the power consumption control request is not received and a case where the power consumption control request is received will be separately described herein.

### (In Case Where the Power Consumption Control Request is not Received)

If the power consumption control request is not received, then the DR calculation unit 11 does not operate. The schedule calculation unit 10 prepares operation schedules by using the schedule conditions previously set and stored in the schedule condition storage unit 9 and the grid CO2 emission intensity received from the grid energy management system 7. At this time, the schedule calculation unit 10 prepares the operation schedules so that the household electric appliances 4-1 to 4-n can operate in the operation-permitting time zones of the schedule conditions, particularly in the time zone during which the grid CO2 emission intensity remains smallest. The operation schedules may be prepared once a day. For example, the operation schedules of the day may be prepared at 00:00.

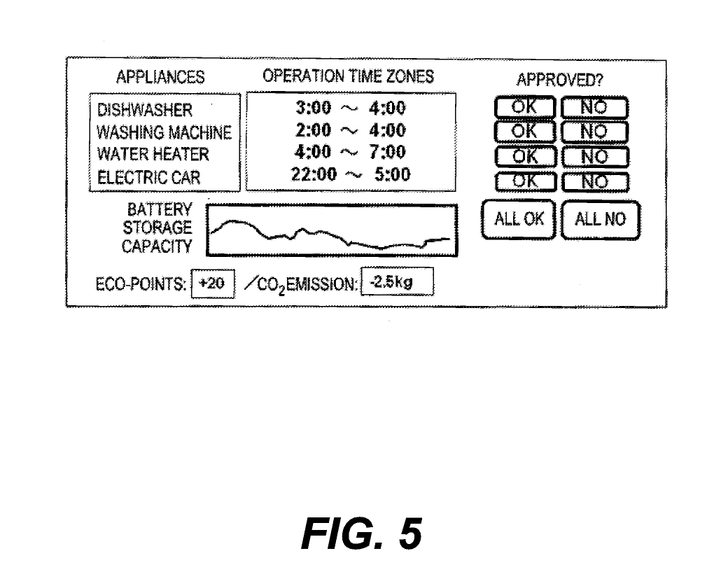

The operation schedules will now be described with reference to FIG. 5, which shows one example of the operation schedules prepared by the schedule calculation unit 10. In this connection, the operation schedules are prepared in such a way as to reduce the CO₂ emission of the household electric appliances 4-1 to 4-n or to reduce the electric power charge proportional to the power consumption. In other words, the household electric appliances 4-1 to 4-n are operated within the extent of the schedule conditions, particularly in the time zone during which the grid CO2 emission intensity is kept small or the time zone during which the unit electricity price remains low.

The “Appliances” in FIG. 5 signify the household electric appliances 4-1 to 4-n. The “Operation Time Zones” stand for the time zones during which the household electric appliances 4-1 to 4-n are allowed to operate. Also displayed on the display unit 3 are the CO₂ emission amount that can be reduced by controlling the household electric appliances 4-1 to 4-n pursuant to the operation schedules and the eco-points indicating an evaluation index determined by the CO₂ emission amount.

Moreover, the display unit 3 displays “OK” buttons and “NO” buttons that can be selected by a dweller. Using an input unit (not shown), the dweller selects one of approval and disapproval options for each of the operation schedules displayed. In case of approval, the dweller selects one or more of the “OK” buttons. In case of disapproval, the dweller selects one or more of the “NO” buttons. The display unit 3 further displays an “ALL OK” button and an “ALL NO” button so that the dweller can select at one time the approval and disapproval options for all the operation schedules.

If the operation schedules are approved by the dweller, then a schedule approval signal is received from the input unit, in response to which the approved operation schedules are stored in the schedule storage unit 13. The control unit 12 controls the household electric appliances 4-1 to 4-n pursuant to the operation schedules stored in the schedule storage unit 13.

### (In Case Where the Power Consumption Control Request is Received)

Next, description will be given on the case where the power consumption control request is received. As set forth above, the schedule calculation unit 10 prepares the operation schedules once a day at a predetermined time. In contrast, the DR calculation unit 11 prepares DR schedules upon receiving the power consumption control request. That is, the DR calculation unit 11 prepares the DR schedules after the operation schedules are prepared by the schedule calculation unit 10. Thus, no description will be given on the preparation of the operation schedules.

The DR calculation unit 11 prepares DR schedules by using the DR conditions previously set and stored in the DR condition storage unit 8 and the power consumption control request and the grid CO2 emission intensity received from the grid energy management system 7.

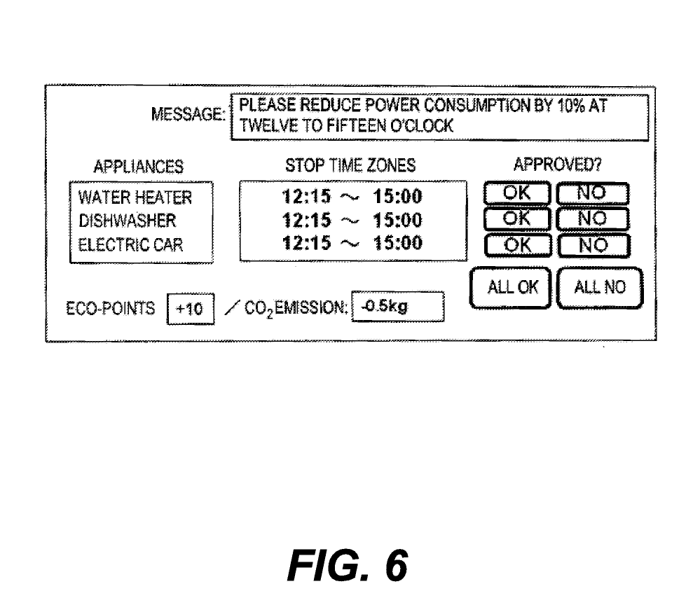

The prepared DR schedules will now be described with reference to FIG. 6, which shows one example of the DR schedules prepared by the DR calculation unit 11.

The “Message” shown in FIG. 6 reads “Please reduce power consumption by 10% at twelve to fifteen o'clock,” which is a sentence specifying the content of control level. Different messages corresponding to control levels are set in advance.

The “Appliances” in FIG. 6 signify the household electric appliances 4-1 to 4-n. The “Stop Time Zones” correspond to the “Appliances” and indicate the time zones during which the household electric appliances 4-1 to 4-n are stopped. The “Appliances” taken as examples in FIG. 6 are the household electric appliances 4-1 to 4-n having higher priority orders, which are selected from the DR conditions stored in the DR condition storage unit 8. More specifically, if the control level of the power consumption control request is “1,” then the household electric appliances 4-1 to 4-n having priority “1” in the DR conditions may be selected as the “Appliances.” If the control level of the power consumption control request is “2,” then the household electric appliances 4-1 to 4-n having priority “1” and priority “2” in the DR conditions may be selected as the “Appliances.”

In case where a battery is included in the household electric appliances 4-1 to 4-n, the change in battery storage capacity caused by the discharge of the battery is displayed on the display unit 3. Further, the display unit 3 may display the CO₂ emission amount, which can be reduced by controlling the household electric appliances 4-1 to 4-n based on the DR schedules, and the eco-points indicating an evaluation index determined by the CO₂ emission amount.

Like the operation schedules, the display unit 3 may display “OK” buttons and “NO” buttons that can be selected by a dweller. Using an input unit (not shown), the dweller selects one of approval and disapproval options for each of the DR schedules displayed. In case of approval, the dweller selects one or more of the “OK” buttons. In case of disapproval, the dweller selects one or more of the “NO” buttons. The display unit 3 may further display an “ALL OK” button and an “ALL NO” button so that the dweller can select at one time the approval and disapproval options for all the DR schedules.

If the DR schedules are approved by the dweller, then a DR approval signal is received from the input unit, in response to which the approved DR schedules are stored in the schedule storage unit 13. The control unit 12 controls the household electric appliances 4-1 to 4-n pursuant to the operation schedules and the DR schedules stored in the schedule storage unit 13. At this time, if the operation schedules and the DR schedules are contradictory to each other, then the DR schedules apply first.

With the household energy management system of the present embodiment, the dweller may just perform the input of approval or disapproval of the operation schedules and the DR schedules. It is not necessary for the dweller to personally perform a task of turning on or off the power of the household electric appliances 4-1 to 4-n. This makes it to easily reduce the CO₂ emission.

Since the schedule calculation unit 10 prepares the operation schedules in light of the grid CO2 emission intensity, it is possible to reduce the CO₂ emission by changing the operation time zones of the household electric appliances 4-1 to 4-n without having to change the operation times thereof.

Inasmuch as the DR calculation unit 11 prepares the DR schedules in view of the power consumption control request, it is possible to eliminate the grid instability (the unintended change in a grid voltage or a grid frequency) due to the installation of a natural energy power plant such as a photovoltaic plant in the grid. This means that natural energy can be introduced into the grid by adopting the household energy management system of the present embodiment in the consumer entity 6.

While the display unit 3 and the input unit (not shown) are independent of each other in the present embodiment, they may be combined into a single unit if the display unit 3 is of a touch panel type. Use of the touch panel type display unit makes it possible to combine the input unit and the display unit 3 together, consequently reducing the cost. Moreover, use of the touch panel type display unit enables the dweller to select one of approval and disapproval options through an instinctive operation.

In the event that the dweller approves the DR schedules prepared pursuant to the power consumption control request received from the grid energy management system 7, the information on the CO₂ emission amount reduced by the approval of the DR schedules and the resultant eco-points may be transmitted to the grid energy management system 7 or an electricity meter (not shown). Using the information thus transmitted, a business entity managing the grid energy management system 7 or the electricity meter can watch the response of the consumer entity 6 to the power consumption control request. Thus, the business entity can give the consumer entity 6 an incentive corresponding to the reduced CO₂ emission amount or the eco-points.

In case where a natural energy power generator such as a photovoltaic power generator is introduced into the consumer entity 6, the operation schedules and the DR schedules are prepared by using the household CO2 emission intensity Uhome represented by equation (2) and not the grid CO2 emission intensity UP mentioned above:

Uhome=(Tbuy×UP+Tsolar×Usolar)/(Tbuy+Tsolar) (2)

wherein Tbuy is the electric energy supplied by the grid, UP is the grid CO2 emission intensity, Tsolar is the photovoltaic power generation amount, and Usolar is the CO2 emission intensity of the photovoltaic power generation, which is calculated and set in advance.

One example of the operation schedule preparing method performed by the schedule calculation unit 10 will be described. If the household electric appliances 4-1 to 4-n are connected in multiple numbers, then an increased processing capacity and a prolonged processing time are required for the schedule calculation unit 10 to calculate the minimized CO₂ emission amount with respect to all the household electric appliances 4-1 to 4-n. In view of this, the operation times of the household electric appliances 4-1 to 4-n are determined so that each of the household electric appliances 4-1 to 4-n having a higher power consumption amount can operate in each of the time zones having a lower grid CO2 emission intensity. This makes it possible to reduce the processing capacity required in the schedule calculation unit 10, which leads to a reduction in cost.

When the operation schedules are prepared by the schedule calculation unit 10, there is a concern that the operation times of the household electric appliances 4-1 to 4-n are concentrated on the time zone having a lower grid CO2 emission intensity, e.g., the midnight time zone during which the percentage of the electric power supplied by nuclear power generation is kept high. In view of this, it is preferable to set a maximum permissible power consumption amount indicating the upper limit of the electric power supply and, by the schedule calculation unit 10, to prepare the operation schedules such that the total power consumption amount of the household electric appliances 4-1 to 4-n in operation does not exceed the maximum permissible power consumption amount. This makes it possible to disperse the operation time zones of the household electric appliances 4-1 to 4-n. If the power consumption amount of appliances operating at all times, e.g., a refrigerator, and the standby power of appliances connected to the household energy management system are included in the maximum permissible power consumption amount, then it becomes possible for the schedule calculation unit 10 to stably and precisely prepare the operation schedules.

In case where a heat pump type water heater for heating water with the heat in the air transferred by a heat pump is used as one of the household electric appliances 4-1 to 4-n, the efficiency of the water heater grows higher in proportion to the temperature of the ambient air, which is attributable to the characteristics of the water heater. It is known that, even if the same quantity of water is heated, the heating can be finished within a short time period under a high-efficiency condition. This means that the amount of the electric power consumed during the water heating process varies with the heating efficiency.

Under this circumstance, the schedule calculation unit 10 receives predicted temperature information from the grid energy management system 7 and calculates the amount of the electric power required in heating a specified amount of water, based on the predicted temperature information and the start time of the operation-permitting time zone of the operation conditions (for example, the start time is twenty three o'clock if the operation-permitting time zone of the heat pump type water heater is from twenty three o'clock to six o'clock of the next day). Then, the same calculation is performed five minutes after the start time. Thereafter, the same calculation is performed every five minute. The schedule calculation unit 10 finishes the calculation if the heating completion time coincides with the end time of the operation-permitting time zone (for example, the end time is six o'clock of the next day if the operation-permitting time zone of the heat pump type water heater is from twenty three o'clock to six o'clock of the next day) or if the heating completion time goes by the end time.

The operation schedules are prepared such that the heat pump type water heater can operate in the time zone having the smallest power consumption amount among the power consumption amounts calculated every five minute in the operation-permitting time zone. By preparing the operation schedules in this manner, it becomes possible to further reduce the power consumption amount.

With the embodiment of the present disclosure, it is possible to operate the household electric appliances in such a manner as to reduce the CO₂ emission while lessening the burden borne by the dweller.

While one embodiment of the present disclosure has been described above, this embodiment is presented by way of example and is not intended to limit the scope of the present disclosure. This embodiment can be modified in many different forms. Various types of omission, substitution and modification may be made without departing from the scope and spirit of the present disclosure. This embodiment and the modifications thereof fall within the scope and spirit of the present disclosure and are included in the scope of the present disclosure recited in the claims and the equivalent thereof

What is claimed is:

1. A household energy management system, comprising:
a schedule condition storage unit for storing schedule conditions that include operation-permitting time zones indicating time zones during which household electric appliances are permitted to operate, necessary operation times indicating operation times taken for the household electric appliances to finish operation, and operation time power consumption amounts indicating electric power consumed during the operation of the household electric appliances; and
a schedule calculation unit for receiving a CO2 emission intensity from a grid energy management system and for preparing operation schedules indicating operation times of the household electric appliances based on the CO2 emission intensity and the schedule conditions.

2. The system of claim 1 further comprising:
a control unit for controlling the household electric appliances based on the operation schedules.

3. The system of claim 1, wherein the schedule calculation unit calculates a CO₂ emission amount attributable to the operation of the household electric appliances based on the CO2 emission intensity and the schedule conditions and prepares the operation schedules such that the CO₂ emission amount is reduced within the extent of the schedule conditions.

4. The system of claim 1, wherein the schedule calculation unit receives a unit electricity price from the grid energy management system and prepares the operation schedules based on the unit electricity price and the schedule conditions.

5. The system of claim 4, wherein the schedule calculation unit calculates an electric power charge attributable to the operation of the household electric appliances based on the unit electricity price and the schedule conditions and prepares the operation schedules such that the electric power charge is reduced within the extent of the schedule conditions.

6. The system of claim 1, wherein the schedule calculation unit causes a display unit to display selection options on approval and disapproval of the operation schedules and the operation times of the household electric appliances and receives a schedule approval signal from an input unit, and wherein the control unit controls the household electric appliances based on the operation schedules for which the schedule approval signal is received.

7. The system of claim 1, wherein the schedule calculation unit causes a display unit to display a CO₂ emission amount that can be reduced by operating the household electric appliances based on the operation schedules.

8. The system of claim 1, wherein the schedule calculation unit causes a display unit to display an evaluation index corresponding to a CO₂ emission amount that can be reduced by operating the household electric appliances based on the operation schedules.

9. The system of claim 1, wherein the schedule calculation unit receives predicted temperature information indicating a predicted ambient air temperature from the grid energy management system and prepares the operation schedules based on the predicted temperature information and the schedule conditions such that an emission amount of CO₂ emitted by operating a heat pump type water heater is reduced.

10. The system of claim 1 further comprising:
a DR condition storage unit for storing DR conditions including control contents of the household electric appliances and priority orders indicating priorities of the control contents; and
a DR calculation unit for receiving a power consumption control request from the grid energy management system and for preparing DR schedules indicating operation times of the household electric appliances based on the DR conditions and the power consumption control request.

11. The system of claim 1 further comprising:
a control unit for controlling the household electric appliances based on the operation schedules and DR schedules.

12. A household energy management system, comprising:
a DR condition storage unit for storing DR conditions including control contents of household electric appliances and priority orders indicating priorities of the control contents; and
a DR calculation unit for receiving a power consumption control request from a grid energy management system and for preparing DR schedules indicating operation times of the household electric appliances based on the DR conditions and the power consumption control request.

13. The system of claim 12 further comprising:
a control unit for controlling the household electric appliances based on the DR schedules.

14. The system of claim 12, wherein the power consumption control request includes control levels indicating indices of required power consumption reduction amounts and control times for which the household electric appliances are required to be controlled, wherein the priority orders are set in advance corresponding to the control levels, and wherein the control unit is configured to control the household electric appliances having the priority orders corresponding to the control levels during the control times.

15. The system of claim 12, wherein the DR calculation unit causes a display unit to display selection options on approval and disapproval of the DR schedules and the operation times of the household electric appliances and receives a DR approval signal from an input unit, and wherein the control unit controls the household electric appliances based on the DR schedules for which the DR approval signal is received.

16. The system of claim 12, wherein the DR calculation unit causes a display unit to display a CO₂ emission amount that can be reduced by operating the household electric appliances based on the DR schedules.

17. The system of claim 12, wherein the DR calculation unit causes a display unit to display an evaluation index corresponding to a CO₂ emission amount that can be reduced by operating the household electric appliances based on the DR schedules.

18. The system of claim 12, wherein if the DR approval signal is received from the input unit, the CO₂ emission amount is transmitted to the grid energy management system or an electricity meter.

19. The system of claim 12, wherein if the DR approval signal is received from the input unit, the evaluation index is transmitted to the grid energy management system or an electricity meter.

20. A method for household energy management comprising:
storing schedule conditions that include operation-permitting time zones indicating time zones during which household electric appliances are permitted to operate, necessary operation times indicating operation times taken for the household electric appliances to finish operation, and operation time power consumption amounts indicating electric power consumed during the operation of the household electric appliances; and
receiving a CO2 emission intensity from a grid energy management system and preparing operation schedules indicating operation times of the household electric appliances based on the CO2 emission intensity and the schedule conditions.
